(19) United States
(12) Patent Application Publication
(10) Pub. No.: US 2011/0131195 A1
(43) Pub. Date: Jun. 2, 2011

(54) NETWORK SEARCH METHOD FOR PROVIDING SEARCH WINDOW DURING EXECUTION OF APPLICATION PROGRAM

(76) Inventor: Yeo Joon La, Namyangju (KR)

(21) Appl. No.: 12/808,675

(22) PCT Filed: Dec. 10, 2008
(86) PCT No.: PCT/KR2008/007284

§ 371 Date: Jun. 16, 2010

(30) Foreign Application Priority Data
Dec. 21, 2007 (KR) 10-2007-0134886

(51) Int. Cl. G06F 17/30

(52) U.S. Cl. 707/706; 707/E17.108

(57) ABSTRACT

The present invention pertains to a network search method for providing a search window during running an application program. The network search method includes displaying a search tool 42 and 46 in a title bar 42 of a current on-going main application program widow among at least one application program window executed and displayed under a multiple-window environment (301), displaying a search keyword entered by a user in the search tool 42 and 46 (302), transmitting the search keyword to the search engine (303), receiving a search result from the search engine (304), generating a search result window (305), and displaying the search result in the search result window (306). The present invention offers the benefits of satisfying an intended search request in a current focal screen without requiring a user's visit to a search site, being applicable to most of current on-going application programs run by the user, and enabling the user to search only when he wants to.

### TECHNICAL FIELD

The present invention generally relates to a method for searching for information over an electronic network. More particularly, the present invention relates to a network search method for, during execution of an application program such as text writing, text reading, or gaming in addition to a Web browser on a local computer of a user, providing a search window to the user so that he can search intended information within a current on-going application program window without visiting a search site on the Web by use of the Web browser.

### BACKGROUND ART

Search engines are well known which search for information in multiple databases connected to an electronic network such as the Internet under a World Wide Web (or Web) environment. To search for intended information, a user invokes a Web browser in his computer connected to the Internet, accesses a search site taking the form of a Web site, and takes some actions such as setting a search range and entering a keyword. In this way, the user can obtain search results from a search engine of the search site on the screen of the Web browser.

The search site-based search method requires that a user visits a specific search site and enters a keyword. For the most part, the user executes various application programs such as text writing, text reading, or gaming on his computer screen, simultaneously with searching. Especially the Windows of Microsoft provides one window each time each of multiple application programs is invoked and positions the user's intended window in the first place on the screen, to thereby enable the user to easily select one of the current on-going application programs.

Referring to FIG. 1, if the user is executing an application program without any relation to search, for example, he is writing text or enjoying a game, he should terminate the on-going application program or minimize the window of the application program in step 101, or execute a Web browser in step 102. When the Web browser is executed, the user enters the Universal Resource Location (URL) of a particular search site manually or selects it from a Bookmarks menu in step 103. Then the user accesses a search server through the search site in step 104 and shifts the cursor of a mouse to a keyword entry window displayed on a Web page of the search site in step 105. After entering an intended keyword in step 106, the user transmits the keyword to the search server in step 107. The Web browser of the user then receives search results obtained by a search engine from the search server in step 108 and displays them on the screen of the Web browser in step 109. After acquiring his intended search result in the above operation, the user should re-execute the application program in order to return to the task that he was working on before the search in step 110.

As described above, the user is required to temporarily discontinue an on-going activity such as text writing or gaming and take an additional action for search in the conventional search site-based search method. This search process is very inconvenient if the user wants an information search only as an auxiliary activity that accompanies a main task, not as a dedicated activity. Accordingly, there exists a need for improving the search method.

To fulfill the need, for example, Korea Patent Application No. 10-2003-0025539 entitled “Local Search Method” discloses a search method in which when a user takes an input action such as clicking a left mouse button on an area empty of a particular object like a space of a Web page, a search tool is executed to receive a query keyword from the user, the received query keyword is transmitted to a remote search engine over a network, and search results are received and displayed on a screen in response to the search request on the current local screen without visiting a particular search site. According to the search method, a simple action such as mouse clicking at a predetermined position of a currently displayed Web site page suffices for starting a search without requiring the user's visit to a particular search site.

However, due to the requirement of the absence of a particular object like an empty space of a Web page invoked by a Web browser, the above search method is not viable in many cases where there is no space without any object in a page, for example, when text or an image is edited or a game environment is displayed. Also, because the user may click the left mouse button inadvertently without any intention for search, an unintended search tool pops up on the screen, which may be bothersome to the user.

Accordingly, there still exists a need for a new search method which satisfies a desired search request on a current local screen without a user's visiting a particular search site, which is applicable to most of application programs currently executed by the user, and enables the user to do a search activity only when he wants to.

### DISCLOSURE OF INVENTION

### Technical Problem

An aspect of embodiments of the present invention is to address at least the problems and/or disadvantages and to provide at least the advantages described below. Accordingly, the present invention intends to provide a network search method for providing a search window to a user during execution of an application program such as text writing, text reading, or gaming in addition to a Web browser on a local computer of the user so that he can search intended information within a current on-going application program window without visiting a particular search site on the Web by use of the Web browser, to thereby satisfy a desired search request on a current local screen without the user's visiting the search site, to thereby be applicable to most of application programs currently executed by the user, and to thereby enable the user to do a search activity only when he wants to.

### Technical Solution

The present invention is achieved by a network search method for providing a search window during running an application program.

In accordance with an aspect of embodiments of the present invention, there is provided a network search method for providing a search window during running an application program so as to search for information directly in a local window under a current multiple-window environment without visiting a search site, in a local computer system connected to a search engine over a network capable of interactive data communications. The network search is implemented by a program installed in the local computer system, for transmitting a search keyword in real time to the search engine over the network and the program includes commands for commanding the local computer system to perform displaying a search tool in a title bar of a current on-going main application program widow among at least one application program window executed and displayed under the multiple-window environment, displaying a search keyword entered by a user in the search tool, transmitting the search keyword to the search engine, receiving a search result from the search engine, generating a search result window, and displaying the search result in the search result window.

It is preferred that the search tool includes a search menu in the form of a tool box, for enabling the user to select a search range, and a keyword entry portion for enabling the user to enter a search keyword.

It is preferred that the search keyword is automatically generated out of a character stream entered by predetermined key inputs in the application program by keyboard hooking or the search keyword is automatically generated in the search tool by sensing movement of a mouse pointer to a predetermined character stream in the application program by message hooking, when the search keyword is displayed in the search tool.

It is preferred that the search result window is a pop-up child window based on the current on-going main application program window.

### Advantageous Effects

Since the present invention provides a network search method for providing a search window to a user during execution of an application program such as text writing, text reading, or gaming in addition to a Web browser on a local computer of the user so that he can search intended information within a current on-going application program window without visiting a particular search site on the Web by use of the Web browser, a desired search request is satisfied on a current local screen without the user's visiting the search site, the network search method is applicable to most of application programs currently executed by the user, and the user can do a search activity only when he wants to.

### BRIEF DESCRIPTION OF THE DRAWINGS

FIG. 1 is a flowchart illustrating a conventional search method using a search site during running an application program;

FIG. 2 is a block diagram of a system for performing a network search method using a search window during running an application program according to an embodiment of the present invention;

FIG. 3 is a flowchart illustrating a search operation without executing a Web browser during running an application program according to an embodiment of the present invention;

FIG. 4 illustrates an exemplary screen that displays a search tool in a title bar of an application program window in the network search method according to the embodiment of the present invention;

FIG. 5 illustrates an exemplary screen that displays searched information with respect to a search keyword entered in the search tool of the application program window in the network search method according to the embodiment of the present invention; and

FIG. 6 illustrates an exemplary main application program window to which the network search method according to the embodiment of the present invention is applied.

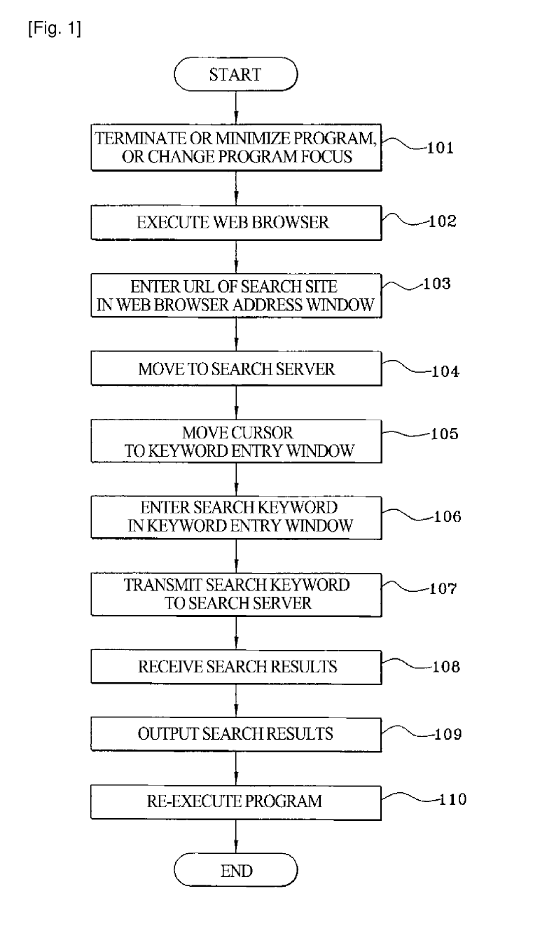

### BRIEF EXPLANATION OF ESSENTIAL PARTS OF THE DRAWINGS

22: local computer,
24: Internet (network)
26: search server,
40: application program window
42: title bar,
44: search menu
46 keyword entry portion,
50: search result window
60: main application program window,
62: sub application program window

### MODE FOR THE INVENTION

With the attached drawings, a network search method for providing a search window during running an application program according to the present invention will be described, taking specific examples.

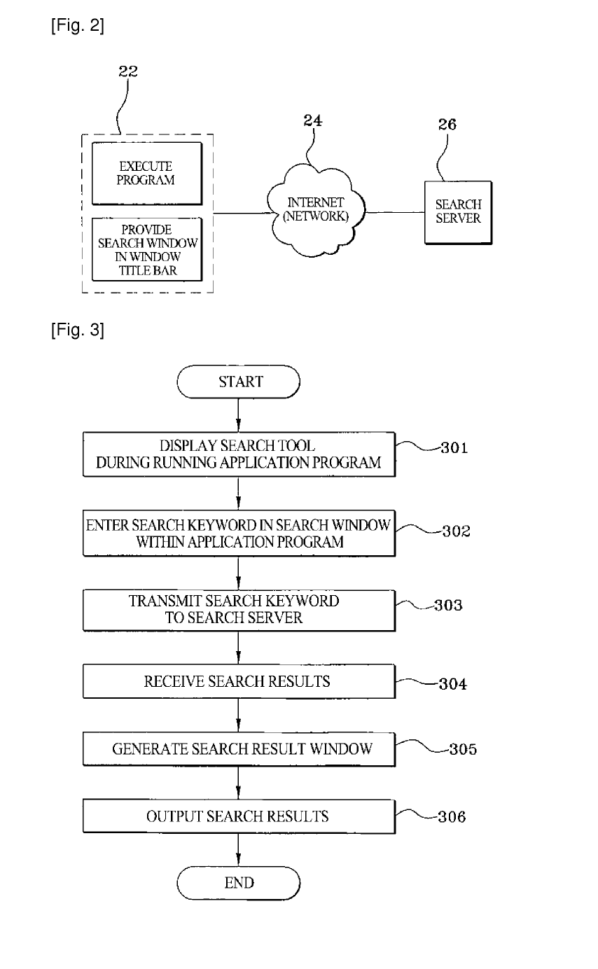

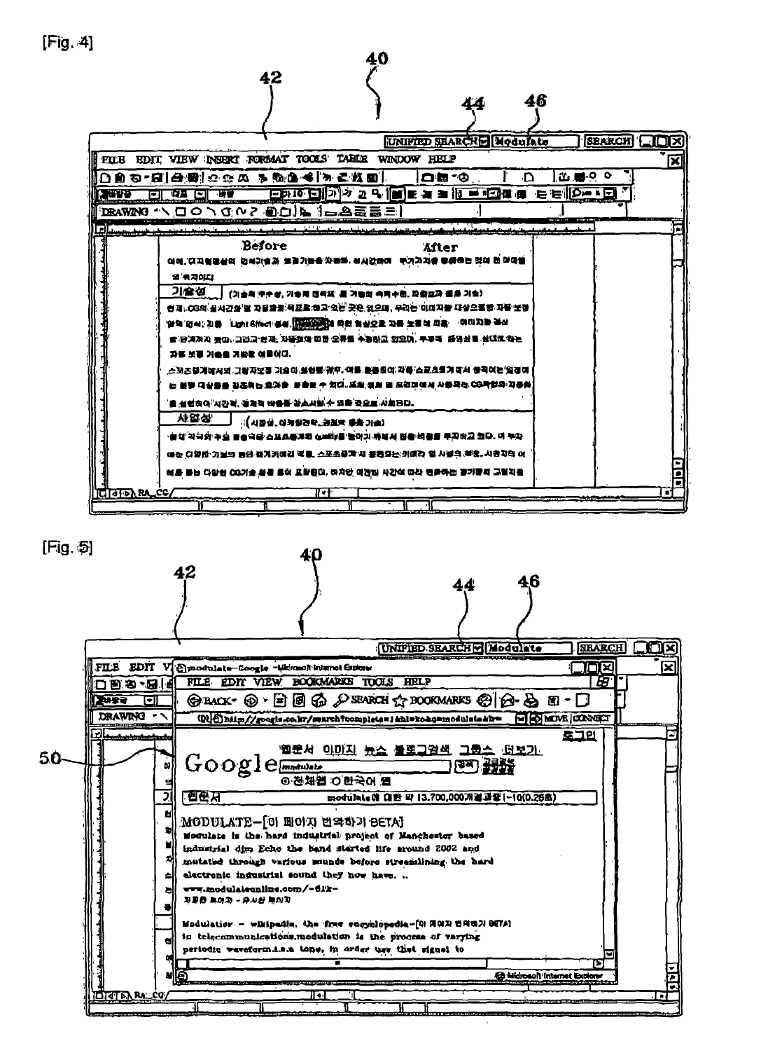

FIG. 2 is a block diagram of a system for performing a network search method using a search window during running an application program according to an embodiment of the present invention, FIG. 3 is a flowchart illustrating a search operation without executing a Web browser during running an application program according to an embodiment of the present invention, and FIGS. 4, 5 and 6 are exemplary views referred to for describing the network search method according to the embodiment of the present invention.

Referring to FIG. 2, a network search method for providing a search window during execution of an application program according to an embodiment of the present invention is applicable to a network system including a local computer system 22 connected to a search engine invoked by a search server 26 over a network 24 capable of interactive data communications by a communication protocol such as Transmission Control Protocol/Internet Protocol (TCP/IP). The local computer system 22 is a client and connected to the search server 24 that provides a search engine service such that interactive data communications can be conducted in a client-server manner.

The client local computer system 22 can be a Personal Computer (PC), a workstation, or a smaller or larger computer system. Typically, each client local computer system includes at least one processor, at least one memory, and at least one input/output device. The server may have a similar configuration to that of the client. While only one search server 26 is illustrated for notational simplicity in FIG. 2, multiple server computer systems are connected to the network 24 in real implementation. Further, while the client local computer 22 is illustrated as a separate entity from the server computer 26 in FIG. 2, the client 22 and the server 26 may be incorporated into a single physical computer device.

A user can invoke various application programs including a text or graphic editing program and a game client program, and a Web browser program for accessing a Web site on the Internet through the client local computer 22. According to the present invention, the client local computer 22 operates in a multiple-window environment such as an OS system of Microsoft, the Windows. Therefore, application programs executed in the local computer 22 are displayed in windows, as illustrated in FIGS. 4, 5 and 6.

The present invention provides a search method in which a user searches for information directly in a local window under a current multiple-window environment without visiting a specific search site. The search method is carried out by a search program installed in the local computer system for transmitting a search keyword to a search engine over a network in real time. The search program is described as the flowchart of FIG. 3 that can be implemented in the local computer system 22 and realized as the search method of the present invention illustrated in FIGS. 4, 5 and 6.

According to the search method of the present invention, a search tool 42 and 46 is displayed within a title bar 42 of an on-going main application program window among one or more application programs executed and displayed in the multiple-window environment in step 301. As illustrated in FIG. 6, when a plurality of application programs are running and thus a plurality of windows 60 and 62 are opened, the search tool is displayed only in the main window 60.

In general, the title bar 42 displays a title of the window on a left side and provides means for reducing a window size or closing the window at a right corner of the window. Much space exists between the title displaying area and the window control means. The present invention provides the search tool in the space to thereby enable the user to simultaneously run an application program and perform a search operation.

In accordance with an embodiment of the present invention, the search tool 42 and 46 includes a search menu 42 in the form of a tool box by which the user can select a search range and a keyword entry portion 46 in which the user enters a search keyword. The search menu 42 can be set to “Unified Search” for example, as a default. The “Unified Search” means the widest search range. Besides, the search menu 42 may include menu items indicating search ranges like search categories specifying the names of search sites of particular search servers, languages, and dictionary types. The search range menu items can be specified in the same manner as known to the conventional search site field. Meanwhile, as to the keyword entry portion 46, the user shifts a mouse pointer to the keyword entry portion 46 and enters a keyword text directly through a keyboard.

In accordance with the search method of the present invention, a search keyword entered in the search tool 42 and 46 by the user is displayed in step 302. The user can enter the search keyword directly using the keyboard or the search keyword can be automatically generated, for user convenience.

It can be further contemplated as another embodiment of the present invention that the search keyword is automatically generated by keyboard hooking or message hooking. The keyboard hooking scheme automatically generates a search keyword in the search tool out of a character stream entered by predetermined key inputs in the application program by keyboard hooking. For instance, when the user enters an automatic keyword generation command by selecting F1, for example, and enters a Korean word [symbol] within the window of a text editing application program, it is determined whether the “Korean/English” key is enabled and keyboard values 0x58, 0x4D, 0x52, 0x47, and 0x4A are replaced with Korean characters [symbol] In this manner, [symbol] is generated automatically in the keyword entry portion 46. Meanwhile, for an English word “APPLE”, it is determined whether the “Caps Lock” key is enabled and then keyboard values 0x41, 0x50, 0x50, 0x4C, and 0x45 are converted to APPLE. In the case of “apple”, it is determined whether they are small letters by checking whether the “Caps Lock” key is disabled.

The message hooking scheme senses movement of a mouse pointer to a particular character stream in the application program and generates a search keyword automatically by message hooking. For a Korean sentence [symbol] in a Word text, the mouse pointer shifts to the word [symbol] and the left mouse button is clicked on the word [symbol] Then the word [symbol] is marked with a block, copied to a clip board, and output to the keyword entry portion 46 of the search tool. Thus, the search keyword is automatically generated.

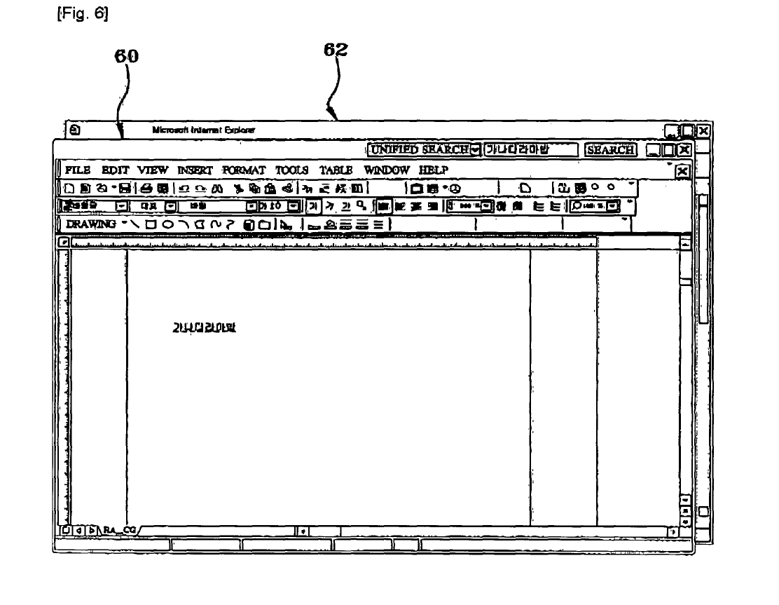

After the search keyword is entered, it is transmitted to a search engine of a search server in step 303. Search results are received from the search engine of the search server in step 304, a search result window is created in step 305, and the search results are displayed in the search result window in step 306. The search result window is a pop-up child window 50 based on the application program window 40 (refer to FIG. 5) or it is the application program window 40 itself in the present invention.

Because the above-described present invention obviates the need for visiting a search site and taking an additional action to open a search tool, the search step is simplified, thereby improving user convenience. In addition, a user can select an intended search server and/or search category, thereby increasing search efficiency. Providing the search tool in the title bar of a window relieves user inconvenience. The present invention advantageously enables the user to use a search service easily simultaneously with running an application program. As search results are displayed in a search result window being a chill window of the application program window, the user can move easily between the search result window and the application program. The present invention also enables both on-line and off-line searches.

### INDUSTRIAL APPLICABILITY

As is apparent from the above description, the present invention provides a search method for providing a search window during running an application program such as text writing, text reading, or gaming in addition to execution of a Web browser on a local computer of a user, so that the user can perform an intended search within an on-going application program window without visiting a search site on the Web using the Web browser. Hence, the search method can find its wide use in the network search field of searching information over an electronic network.

1. A network search method for providing a search window during running an application program so as to search for information directly in a local window under a current multiple-window environment without visiting a search site, in a local computer system connected to a search engine over a network capable of interactive data communications, the method being implemented by a program installed in the local computer system, for transmitting a search keyword in real time to the search engine over the network and the program including commands for commanding the local computer system to perform:
displaying a search tool 42 and 46 in a title bar 42 of a current on-going main application program widow among at least one application program window executed and displayed under the multiple-window environment (301);
displaying a search keyword entered by a user in the search tool 42 and 46 (302);
transmitting the search keyword to the search engine (303);
receiving a search result from the search engine (304);
generating a search result window (305); and
displaying the search result in the search result window (306).

2. The network search method of claim 1, wherein the search tool 42 and 46 includes a search menu 42 in the form of a tool box, for enabling the user to select a search range, and a keyword entry portion 46 for enabling the user to enter a search keyword.

3. The network search method of claim 1, wherein displaying the search keyword in the search tool 42 and 46 comprises one of generating the search keyword automatically out of a character stream entered by predetermined key inputs in the application program by keyboard hooking and generating the search keyword automatically in the search tool by sensing movement of a mouse pointer to a predetermined character stream in the application program by message hooking.

4. The network search method of claim 1, wherein the search result window is a pop-up child window based on the current on-going main application program window.
